(19) United States
(12) Patent Application Publication
(10) Pub. No.: US 2026/0156131 A1
(43) Pub. Date: Jun. 4, 2026

(54) METHOD OF AUGMENTING CYBER-ATTACK CAMPAIGN DATA TO IDENTIFY ATTACK GROUP, AND SECURITY SYSTEM PERFORMING THE SAME

(71) Applicant: AGENCY FOR DEFENSE DEVELOPMENT, Daejeon (KR)

(72) Inventors: Changhee CHOI, Daejeon (KR); Insup LEE, Daejeon (KR)

(73) Assignee: AGENCY FOR DEFENSE DEVELOPMENT, Daejeon (KR)

(21) Appl. No.: 19/244,041

(22) Filed: Jun. 20, 2025

(30) Foreign Application Priority Data
Dec. 2, 2024 (KR) 10-2024-0176082

(51) Int. Cl. H04L 9/40; H04L 41/14

(52) U.S. Cl. CPC H04L 63/1425; H04L 41/145

(57) ABSTRACT

A method of augmenting cyber-attack campaign data for identifying an attack group includes: selecting one of a plurality of cyber-attack campaign data for a selected target group from among a plurality of attack groups as seed campaign data; replacing a first TTP included in a TTP sequence of the selected seed campaign data with a second TTP included in a synonym range; and applying a TTP sequence including the replaced second TTP as cyber-attack campaign data for the target group, wherein the replacing the first TTP with the second TTP includes replacing the first TTP with the second TTP that satisfies predefined condition setting information from among a plurality of TTPs included in a synonym range of the first TTP.

### CROSS-REFERENCE TO RELATED APPLICATION

This application claims the benefits of Korean Patent Application No. 10-2024-0176082, filed on Dec. 2, 2024, in the Korean Intellectual Property Office, the disclosures of which are incorporated herein in their entireties by reference.

### BACKGROUND

### 1. Field

The inventive concept of the disclosure relates to a method of augmenting cyber-attack campaign data for identification of an attack group, and a security system performing the same.

### 2. Description of the Related Art

With the recent advancement of IT technology, all devices in our daily lives are connected to each other through networks, beyond simple Internet of things (IoT), which maximizes convenience and productivity in life. However, as various devices are connected to each other and networks become more complex, attack vectors also increase, and damage caused by cyber threats may worsen. In particular, due to these changes, the paradigm of cyber-attacks is shifting from traditional cyber-attacks to advanced persistent threats (APTs) and cyber-attack campaigns.

In order to proactively defend and mitigate cyber-attack campaigns, the concept of cyber threat intelligence (CTI) has emerged. CTI means continuously collecting knowledge from various intelligence sources such as kernel logs and network traffic to deeply understand the attacker's intentions and context. The most important factor in ensuring the performance of such CTI is collecting a sufficient amount of reliable campaign data.

However, in the case of large-scale attacks such as nation-state sponsored campaigns, the frequency of attacks may be low due to the time and resources required to prepare for an attack, making it difficult to collect sufficient campaign data. As a result, there is a problem that the performance of CTI for large-scale attacks is relatively low.

### SUMMARY

One or more embodiments include a method to obtain a large amount of campaign data to accurately identify an attack group for a cyber-attack campaign.

One or more embodiments include a security system capable of more accurately identifying an attack group for a cyber-attack campaign by securing a large amount of campaign data.

According to an aspect of an inventive concept of the disclosure, a method of augmenting cyber-attack campaign data for identifying an attack group, performed by at least one computing device, includes: selecting one of a plurality of cyber-attack campaign data for a selected target group from among a plurality of attack groups as seed campaign data; replacing a first TTP included in a TTP (Tactics, Techniques, Procedures) sequence of the selected seed campaign data with a second TTP included in a synonym range; and applying a TTP sequence including the replaced second TTP as cyber-attack campaign data for the target group, wherein the replacing the first TTP with the second TTP includes: replacing the first TTP with the second TTP that satisfies predefined condition setting information from among a plurality of TTPs included in a synonym range of the first TTP.

According to an embodiment, the selecting one of a plurality of cyber-attack campaign data as seed campaign data may include selecting one of a plurality of cyber-attack campaign data as seed campaign data based on whether a target tactic is included, wherein the target tactic comprises at least one of Collection, Exfiltration, and Impact.

According to an embodiment, the selecting one of a plurality of cyber-attack campaign data as seed campaign data may include selecting one of a certain number of cyber-attack campaign data having a longest TTP sequence length from among the plurality of cyber-attack campaign data for the target group as the seed campaign data.

According to an embodiment, the second TTP included in the synonym range may be a TTP corresponding to one of techniques included in a same tactic as the first TTP.

According to an embodiment, the replacing the first TTP with the second TTP may include randomly selecting a position of a TTP to be replaced from among a plurality of TTPs included in the TTP sequence of the selected seed campaign data; and replacing the first TTP corresponding to the selected position with the second TTP included in the synonym range.

According to an embodiment, the condition setting information may include at least one of replacement exclusion information, replacement probability information, and dependency information, the replacement exclusion information may include information indicating a condition for a tactic to be excluded when selecting a position of a TTP to be replaced, the replace probability information may include information about a replacement probability for each tactic, and the dependency information may include information about a dependency relationship between tactics and techniques.

According to an embodiment, the randomly selecting a position of a TTP to be replaced from among a plurality of TTPs may include among the plurality of TTPs, randomly selecting the position of the TTP to be replaced from at least one TTP from among remaining TTPs excluding at least one TTP corresponding to the replacement exclusion information.

According to an embodiment, the randomly selecting a position of a TTP to be replaced from among a plurality of TTPs may include randomly selecting a position of a TTP to be replaced from among a plurality of TTPs by reflecting the replacement probability information.

According to an embodiment, the replacing the first TTP corresponding to the selected position with the second TTP included in the synonym range may include when the second TTP has a dependency relationship according to the dependency information, respectively replacing at least one TTP included in the TTP sequence with TTPs corresponding to the dependency relationship.

According to an aspect of an inventive concept of the disclosure, a security system comprising at least one computing device, includes: a memory storing at least one instruction; and at least one processor, wherein the at least one processor, by processing the at least one instruction, is configured to: select one of a plurality of cyber-attack campaign data for a selected target group from among a plurality of attack groups as seed campaign data; replace a first TTP included in a TTP (Tactics, Techniques, Procedures) sequence of the selected seed campaign data with a second TTP included in a synonym range and satisfying predefined condition setting information; and reflect a TTP sequence including the replaced second TTP as cyber-attack campaign data for the target group in group attribute information.

According to an embodiment, the security system may further include a communication interface connected to a target system and receiving data generated in relation to the target system, wherein the at least one processor may be configured to: collect security event data from the received data; obtain a TTP sequence corresponding to a cyber-attack campaign from the collected security event data; identify an attack group of the cyber-attack campaign based on the obtained TTP sequence and the group attribute information; and execute security response measures for the cyber-attack campaign based on an identification result.

According to an embodiment, the at least one processor may be configured to: convert the TTP sequence corresponding to the cyber-attack campaign into sequence data in the form of text; convert the converted sequence data into a campaign vector; and identify the attack group based on similarities between a plurality of campaign vectors for each of a plurality of attack groups included in the group attribute information and the converted campaign vector.

According to an aspect of an inventive concept of the disclosure, a computer program may be stored on a non-transitory computer-readable recording medium for executing the above-mentioned method of augmenting cyber-attack campaign data on a computer.

### BRIEF DESCRIPTION OF THE DRAWINGS

Embodiments of the disclosure will be more clearly understood from the following detailed description taken in conjunction with the accompanying drawings in which:

FIG. 1 is a conceptual diagram for schematically explaining a security system according to an embodiment;

FIG. 2 is a schematic view of a configuration of a security system according to an embodiment;

FIG. 3 is an exemplary view of a configuration of an attack group identification unit shown in FIG. 2;

FIG. 4 is an exemplary view of a configuration of a data augmentation unit shown in FIG. 2;

FIG. 5 is an exemplary view for a specific explanation of a TTP synonym replacement operation performed by a TTP synonym replacement unit shown in FIG. 4;

FIG. 6 is a flowchart for explaining a method of augmenting cyber-attack campaign data according to an embodiment;

FIG. 7 is a flowchart for explaining a method of operating a security system according to an embodiment; and

FIG. 8 is a schematic hardware configuration block diagram of a computing device configuring a security system according to an embodiment.

### DETAILED DESCRIPTION

Embodiments according to the inventive concept are provided to more completely explain the inventive concept to one of ordinary skill in the art, and the following embodiments may be modified in various other forms and the scope of the inventive concept is not limited to the following embodiments. Rather, these embodiments are provided so that this disclosure will be thorough and complete, and will fully convey the scope of the inventive concept to one of ordinary skill in the art.

It will be understood that, although the terms first, second, etc. may be used herein to describe various members, components, regions, layers, and/or sections, these members, components, regions, layers, and/or sections should not be limited by these terms. These terms do not denote any order, quantity, or importance, but rather are only used to distinguish one component, region, layer, and/or section from another component, region, layer, and/or section. Thus, a first member, component, region, layer, or section discussed below could be termed a second member, component, region, layer, or section without departing from the teachings of embodiments. For example, as long as within the scope of this disclosure, a first component may be named as a second component, and a second component may be named as a first component.

Unless otherwise defined, all terms (including technical and scientific terms) used herein have the same meaning as commonly understood by one of ordinary skill in the art to which embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

In addition, terms including “unit,” “er,” “or,” “module,” and the like disclosed in the specification mean a unit that processes at least one function or operation and this may be implemented by hardware or software such as a processor, a micro processor, a micro controller, a central processing unit (CPU), an application processor (AP), a graphics processing unit (GPU), a neural processing unit (NPU), an accelerated Processing unit (APU), a digital signal processor (DSP), an application specific integrated circuit (ASIC), and a field programmable gate array (FPGA) or a combination of hardware and software. Furthermore, the terms may be implemented in a form coupled to a memory that stores data necessary for processing at least one function or operation.

Furthermore, components of the specification are divided in accordance with a main function of each component. That is, two or more components to be described later below may be combined into one component, or one components may be divided into two or more components according to more subdivided functions. In addition, it goes without saying that each of the components to be described later below may additionally perform some or all of the functions of other components in addition to its own main function, and some of the main functions that each of the components is responsible for may be dedicated and performed by other components.

As used herein, the term “and/or” includes any and all combinations of one or more of the associated listed items.

Hereinafter, embodiments of the inventive concept will be described in detail with reference to the accompanying drawings.

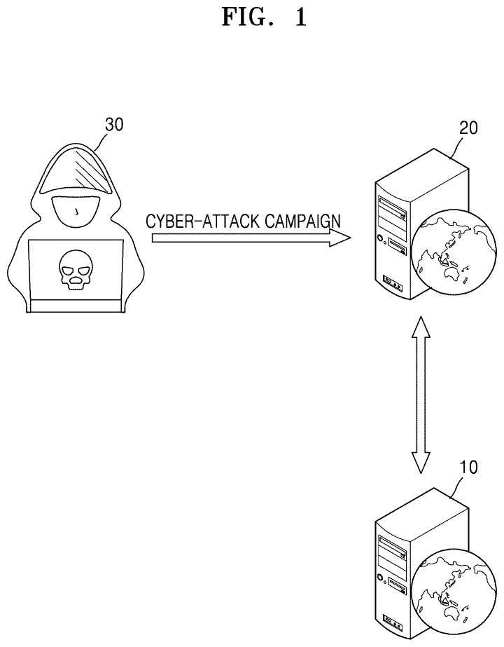

FIG. 1 is a conceptual diagram for schematically explaining a security system according to an embodiment.

Referring to FIG. 1, a security system 10 may correspond to a computing system that detects a cyber-attack of an attack group (or attacker) 30 on a target system 20 and performs or induces security response measures to prevent the target system 20 from being damaged by the detected cyber-attack or information and/or data stored in the target system 20 from being leaked. The security system 10 may be configured to include at least one computing device, and each of the at least one computing device may include hardware such as a processor and memory. In FIG. 1, the security system 10 is illustrated as a separate system connected to the target system 20, but according to an embodiment, the security system 10 may be implemented in a form included within the target system 20.

According to an embodiment, the security system 10 may perform or induce security response measures to protect the target system 20 and information and/or data stored in the target system 20 from a cyber-attack campaign of the attack group 30.

A cyber-attack campaign refers to a series of planned cyber-attack activities with a specific goal or purpose, and unlike individual hacking attempts or one-time attacks, it is carried out in a continuous and systematic manner. Such cyber-attack campaigns generally target specific companies, government agencies, or industries, and their main purposes may be data theft, system paralysis, financial gain, or political/social chaos. An attack group of a cyber-attack campaign uses a multi-stage attack strategy, and may systematically perform various stages such as reconnaissance, initial intrusion, privilege escalation, and data theft/destruction. In particular, the cyber-attack campaign may last for a short period of time, or even for several weeks, months, or years, and may periodically monitor the target system 20 to plan additional attacks. Such cyber-attack campaigns may not be effectively defended by security systems that only detect and respond to conventional one-time attacks.

Accordingly, the concept of cyber threat intelligence (CTI) emerged, which continuously collects knowledge from various intelligence sources (kernel logs, network traffic, etc.) to understand the intention and context of the attack group 30. CTI may provide practical insight and response strategies for cyber-attacks through the process of collecting data from intelligence sources, deriving meaningful threat information based on the collected data, and utilizing (firewall rules or IDS updates, security policy adjustments, attack prevention and response training, etc.) the derived threat information in security strategies.

Such CTI may include the types of strategic threat intelligence (Strategic CTI), tactical threat intelligence (Tactical CTI), and operational threat intelligence (Operational CTI). Among these, tactical threat intelligence focuses on high-level indicators of compromise, such as tactics, techniques, and procedures (TTPs), enabling analysis of a cyber-attack campaign. Tactics may indicate the purpose or goal (e.g., initial access, privilege escalation, data theft, etc.) of a cyber-attack campaign conducted by the attack group 30. Techniques refer to techniques (e.g., initial access attempt via phishing email, etc.) used to achieve each tactic, and procedures refer to specific methods (e.g., types of malicious files used in phishing emails, etc.) of executing specific techniques. MITRE presents an ATT&CK (Adversarial Tactics, Techniques & Common Knowledge) framework that systematically organizes TTPs used by an attack group, and updates the framework as new TTPs emerge. Through these TTPs, information such as a method or pattern of a cyber-attack campaign preferred or mainly operated by a specific attack group is obtained, so that an attack group for a cyber-attack campaign detected later may be identified.

An important factor related to the performance of CTI, that is, the accuracy of identifying the attack group, is collecting a sufficient amount of reliable campaign data. However, large-scale attacks such as a cyber-attack campaign require a lot of time and resources to plan and prepare for the attack, so the attack frequency may be relatively low. This may act as an obstacle in improving the performance of CTI by collecting a sufficient amount of campaign data.

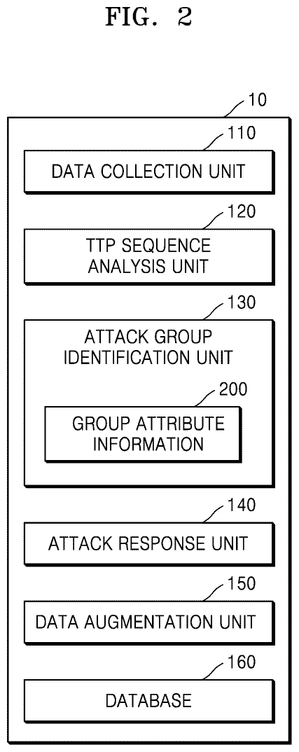

The security system 10 according to an embodiment is a CTI-based system described above, and may be implemented to identify an attack group of a corresponding cyber-attack campaign from data of a detected cyber-attack campaign. In particular, the security system 10 may improve the accuracy of identifying an attack group by securing a large number of campaign data through augmentation of campaign data collected for each attack group. Specific examples related to the security system 10 are described below through FIGS. 2 to 7.

FIG. 2 is a schematic view of a configuration of a security system according to an embodiment.

Referring to FIG. 2, the security system 10 may include a data collection unit 110, a TTP sequence analysis unit 120, an attack group identification unit 130, an attack response unit 140, a data augmentation unit 150, and a database 160. As described above in FIG. 1, because the security system 10 is composed of at least one computing device, each of at least one computing device may correspond to at least some of components of FIG. 2.

The data collection unit 110 may collect various data related to the target system 20 and detect security abnormalities (security events) related to cyber-attacks based on the collected data. For example, the data collection unit 110 may collect data (network packets, etc.) transmitted and received by the target system 20 through a network and/or log data of the target system 20. The data collection unit 110 may detect security abnormalities for the target system 20 from the collected data. For example, the data collection unit 110 may detect security events of the target system 20 by utilizing data exploration tools such as Kibana. According to an embodiment, the data collection unit 110 may detect security events of the target system 20 through linkage with an intrusion detection system (IDS) or an intrusion prevention system (IPS) of the target system 20.

The data collection unit 110 may provide data corresponding to the detected security events to the TTP sequence analysis unit 120. According to an embodiment, the data collection unit 110 may tag at least one piece of TTP information corresponding to each of the detected security events based on MITRE ATT&CK, and provide data tagged with the TTP information to the TTP sequence analysis unit 120.

When data corresponding to a security event is provided from the data collection unit 110, the TTP sequence analysis unit 120 may analyze a TTP sequence for a cyber-attack campaign based on the provided data. In general, because a large-scale cyber-attack campaign may be related to a plurality of security events, the data provided from the data collection unit 110 may include multiple pieces of data corresponding to each of the plurality of detected security events.

According to an embodiment, when TTP information is tagged to each data provided from the data collection unit 110, the TTP sequence analysis unit 120 may obtain a TTP sequence by sorting TTPs based on the tagged TTP information. According to an embodiment, when TTP information is not tagged to each data provided from the data collection unit 110, the TTP sequence analysis unit 120 may obtain a TTP sequence by allocating a plurality of TTPs corresponding to the plurality of detected security events based on MITRE ATT&CK and sorting the allocated plurality of TTPs.

According to an embodiment, the TTP sequence analysis unit 120 may also adjust an order of the TTPs according to a cyber kill chain process for the obtained TTP sequence.

The TTP sequence analysis unit 120 may provide the TTP sequence obtained through analysis of the data provided from the data collection unit 110 to the attack group identification unit 130.

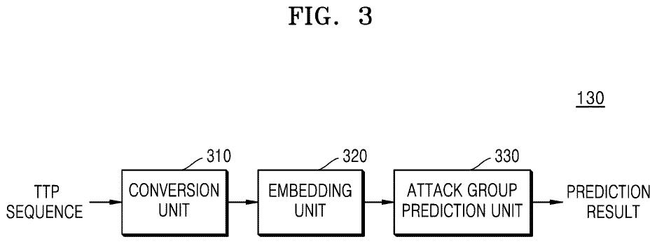

The attack group identification unit 130 may identify an attack group based on the TTP sequence provided from the TTP sequence analysis unit 120. For example, the attack group identification unit 130 may identify an attack group corresponding to a cyber-attack campaign from the TTP sequence by utilizing group attribute information 200 including a plurality of campaign data for each of attack groups. The attack group identification unit 130 will be described in more detail later with reference to FIG. 3.

The attack response unit 140 may set and execute appropriate security response measures for the target system 20 based on the TTP sequence and the identified attack group, or may induce an administrator or the like to execute security response measures. For example, the security response measures may include various previously known measures such as network isolation, system patching, access permission restriction, and deletion of files related to detected threats.

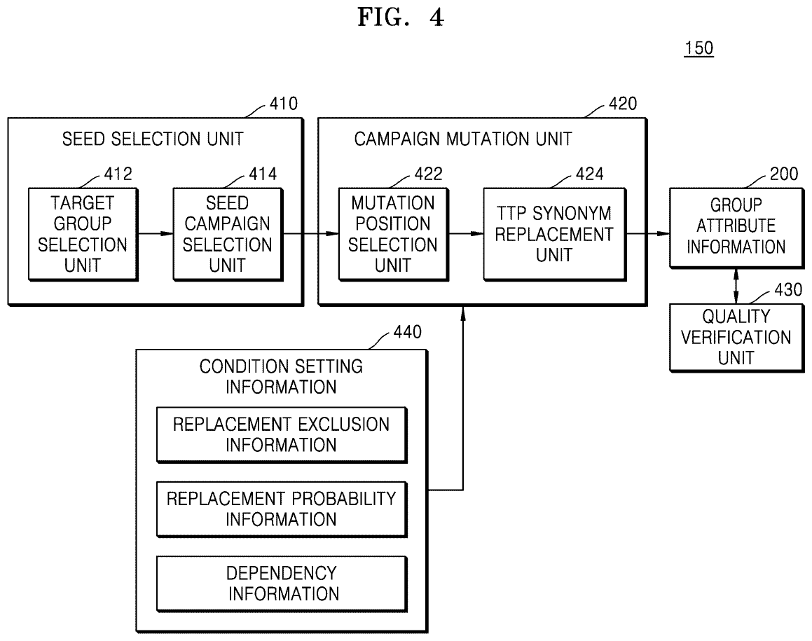

The data augmentation unit 150 may generate a plurality of campaign data by augmenting campaign data (cyber-attack campaign data) for a specific attack group, and reflect the generated campaign data in the group attribute information 200. Accordingly, because a sufficient amount of campaign data is secured for each attack group, the attack group identification unit 130 may more accurately identify an attack group for a detected cyber-attack campaign. A more specific description of the data augmentation unit 150 will be described later with reference to FIGS. 4 to 6.

The database 160 may store and manage various data related to operations of the security system 10. For example, the database 160 may store and manage various data such as data collected through the data collection unit 110, TTP sequence data obtained through the TTP sequence analysis unit 120, attack group identification information obtained by the attack group identification unit 130, group attribute information 200, and/or security response measure history. In FIG. 2, the database 160 is illustrated as being included in the security system 10, but may be implemented as a separate configuration (database server, data center, etc.) connected to the security system 10 according to an embodiment.

FIG. 3 is an exemplary view of a configuration of an attack group identification unit shown in FIG. 2.

Referring to an embodiment of FIG. 3, the attack group identification unit 130 may include a conversion unit 310, an embedding unit 320, and an attack group prediction unit 330.

The conversion unit 310 may convert the TTP sequence provided from the TTP sequence analysis unit 120 into data in the form of text (sequence data). For example, the conversion unit 310 may obtain sequence data by considering each TTP included in the TTP sequence as a word and expressing the entire TTP sequence in the form of a sentence (text string).

The embedding unit 320 may convert the sequence data converted into the form of text into a low-dimensional embedding vector (campaign vector). For example, the embedding unit 320 may convert the sequence data into a campaign vector by utilizing an embedding technique such as Camp2Vec. Camp2Vec may convert data related to cyber-attacks into vectors by applying an embedding technique used in natural language processing (NLP) so that it can be used for machine learning/deep learning or analysis. Camp2Vec may convert sequence data into a campaign vector by utilizing Term Frequency-Inverse Document Frequency (TF-IDF), a statistical method that expresses the importance of specific words in a document set. However, a method (algorithm) by which the embedding unit 320 converts sequence data into a campaign vector is not limited thereto.

The attack group prediction unit 330 may predict an attack group for a cyber-attack campaign based on the campaign vector converted by the embedding unit 320 and the group attribute information 200.

For example, the attack group prediction unit 330 may calculate a similarity score for each of attack groups based on similarities between a plurality of campaign vectors obtained or augmented for each of attack groups included in the group attribute information 200 and the converted campaign vector, and predict an attack group based on the calculated similarity score. In more detail, when calculating a similarity score for a first attack group from among the attack groups, the attack group prediction unit 330 may calculate similarities (e.g., cosine similarities) between each of a plurality of campaign vectors for the first attack group and the converted campaign vector, and calculate a similarity score for the first attack group by calculating an average of the calculated similarities. The attack group identification unit 200 may predict an attack group with the highest calculated similarity score as the attack group for the cyber-attack campaign.

According to an embodiment, the attack group prediction unit 330 may include an attack group prediction model trained (machine learning or deep learning) using the group attribute information 200. In this case, the embedding unit 320 described above may be omitted. The attack group prediction model may be trained to receive a TTP sequence obtained from the TTP sequence analysis unit 120 or sequence data obtained from the conversion unit 310, and output a prediction result of an attack group from the input TTP sequence or sequence data. For example, the attack group prediction model may be implemented as various models such as a random forest model and BERT.

A prediction result of the attack group prediction unit 330 may be provided to the attack response unit 140 as an identification result of the attack group identification unit 130.

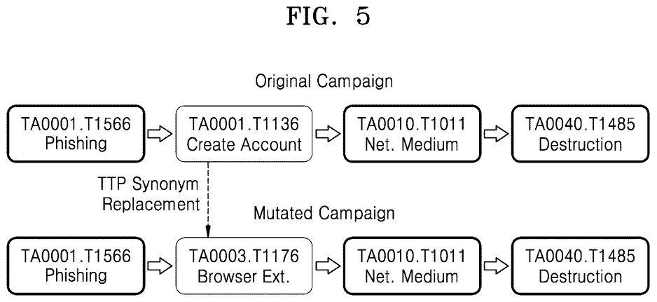

FIG. 4 is an exemplary view of a configuration of a data augmentation unit shown in FIG. 2. FIG. 5 is an exemplary view for a specific explanation of a TTP synonym replacement operation performed by a TTP synonym replacement unit shown in FIG. 4.

Referring to FIG. 4, the data augmentation unit 150 may include a seed selection unit 410 and a campaign mutation unit 420, and may further include a quality verification unit 430 according to an embodiment.

The seed selection unit 410 is a configuration that selects reference campaign data (seed campaign data) for augmenting campaign data, and may include, for example, a target group selection unit 412 and a seed campaign selection unit 414.

The target group selection unit 412 may select one attack group from among a plurality of attack groups as a target group for augmenting campaign data based on an administrator's input or a certain selection criterion. Thereafter, campaign data generated by the campaign mutation unit 420 may be reflected (stored and managed) in the group attribute information 200 as campaign data for the target group.

The seed campaign selection unit 414 corresponds to a configuration that selects one of multiple campaign data for the selected target group as seed campaign data. For example, the seed campaign selection unit 414 may select seed campaign data based on whether a target tactic is included and/or the length of a TTP sequence, but selection criteria for the seed campaign data may vary. For example, the target tactic may include collection, exfiltration, and impact as a major tactic for achieving an attack goal of an attack group. In addition, in order to select campaign data that includes a comprehensive and sophisticated attack process of an attack group when selecting seed campaign data, campaign data with a relatively long TTP sequence length (e.g., one of a certain number of campaign data with the longest TTP sequence length from among a plurality of campaign data for a target group) may be selected, but is not limited thereto.

The campaign mutation unit 420 corresponds to a configuration that augments campaign data by changing at least one TTP in a TTP sequence of seed campaign data selected by the seed selection unit 410 to another TTP. According to an embodiment, the campaign mutation unit 420 may include a mutation position selection unit 422 and a TTP synonym replacement unit 424.

The mutation position selection unit 422 is a configuration that selects a position (mutation position) of a TTP to be changed from among a plurality of TTPs included in the TTP sequence, and for example, the mutation position may be randomly selected. According to an embodiment, the mutation position selection unit 422, among the plurality of TTPs included in the TTP sequence, may select a position of a TTP to be changed from among the remaining TTPs excluding TTPs corresponding to the target tactic described above.

The TTP synonym replacement unit 424 may change the TTP of the selected position to another TTP. In more detail, the TTP synonym replacement unit 424 may change the TTP of the selected position to a TTP included in a synonym range of the corresponding TTP. The synonym range may mean techniques included in the same tactic as the corresponding TTP. Referring to the exemplary view of FIG. 5, a TTP sequence of seed campaign data (original campaign of FIG. 5) may be composed of TA0001.T1566 (‘phishing’ technique of ‘initial access’ tactic)→TA0003.T1136 (‘account creation’ technique of ‘persistence’ tactic) →TA0010.T1011 (‘exfiltration through other network media’ technique of ‘exfiltration’ tactic) →TA0040.T1485 (‘data destruction’ technique of ‘influence’ tactic). When the TA0003.T1136 TTP of the second position is selected by the mutation position selection unit 422, the TTP synonym replacement unit 424 may replace the TTP of the selected position with another TTP (e.g., TA0003.T1176 (‘browser extension’ technique of ‘persistence’ tactic)) corresponding to a synonym range (another technique included in the same tactic). According to the replacement of the TTP, changed campaign data (mutated campaign) may be generated from the seed campaign data.

According to an embodiment, the campaign mutation unit 420 may perform selection of mutation positions and/or replacement of TTP synonyms according to preset conditions. For example, condition setting information 440 corresponding to the preset conditions may include replacement exclusion information, replacement probability information, and/or dependency information as conditions based on domain knowledge.

The replacement exclusion information corresponds to information indicating conditions for tactics to be excluded when selecting mutation positions. For example, the tactics to be excluded may include Reconnaissance, Resource Development, and Impact. The Reconnaissance and Resource Development tactics correspond to tactics that are usually impossible for the security system 10 to detect. Influence tactics are important elements corresponding to the purpose of a corresponding cyber-attack campaign, and as they change, they have the potential to change the nature of an attack, so they may be excluded when selecting mutation positions.

The replacement probability information may include information about replacement probability for each tactic. The mutation position selection unit 422 may randomly select a mutation position by reflecting the replacement probability information, and as a result, a position of a TTP corresponding to a tactic with a relatively high substitution probability is more likely to be selected as a mutation position. A replacement probability for each tactic may be set according to various criteria, such as whether each tactic changes the nature or purpose of a cyber-attack campaign. For example, the replacement probability information may be obtained by classifying each tactic according to a change probability tier, and specific classification examples may be as follows.
Tier 1 (highest replacement probability): Discovery, Collection
Tier 2: Execution, Persistence, Exfiltration
Tier 3: Command and Control, Credential Access, Defense Evasion
Tier 4 (lowest replacement probability): Privilege Escalation, Lateral Movement

Dependency information is information indicating a dependency relationship between tactics and/or technologies, and the TTP synonym replacement unit 424, when a replaced TTP has a tactic and/or technique included in the dependency relationship, may replace at least one TTP corresponding to another position that is not selected as a mutation position with another TTP based on the dependency relationship.

For example, a Remote Service technique of Lateral Movement needs to first obtain a password through Credential Access and search for IPs, etc. through a Remote System Discovery technique of Discovery. If a TTP of a selected mutation position is replaced with a TTP having the Remote Service technique of Lateral Movement, the TTP synonym replacement unit 424 may replace technologies of TTPs having Credential Access tactics and Discovery tactics in the TTP sequence of the seed campaign data according to the dependency relationship described above.

Because the condition setting information 440 described above is applied, the campaign mutation unit 420 may generate more realistic campaign data reflecting domain knowledge when generating new campaign data through augmentation of campaign data.

The data augmentation unit 150 may reflect the generated campaign data as campaign data for a target group in the group attribute information 200.

The quality verification unit 430 may verify the quality of the attack group identification unit 130 according to the group attribute information 200 augmented with campaign data by determining a change in attack group identification accuracy as the campaign data generated by the seed selection unit 410 and the campaign mutation unit 420 is reflected in the group attribute information 200. For example, the quality verification unit 430 may identify an attack group using a campaign dataset labeled by an expert, etc., and determine a change in attack group identification accuracy through a comparison between an identification result and the label. According to an embodiment, when the attack group identification accuracy decreases to a threshold value or more than a threshold value due to augmentation of campaign data, the augmented campaign data may be deleted from the group attribute information 200.

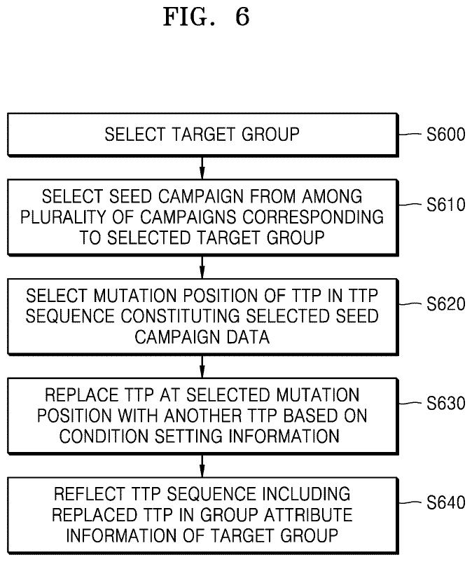

FIG. 6 is a flowchart for explaining a method of augmenting cyber-attack campaign data according to an embodiment.

Referring to FIG. 6, the method of augmenting cyber-attack campaign data according to an embodiment may include operation S600 of selecting an attack group (target group) to augment campaign data, and operation S610 of selecting a seed campaign (seed campaign data) from among a plurality of campaigns corresponding to the selected target group.

The plurality of campaigns corresponding to the selected target group may be stored in the database 160, but are not limited thereto. According to an embodiment, the seed campaign may be selected based on whether a target tactic is included and/or the length of a TTP sequence.

The method of augmenting may include operation S620 of selecting a mutation position of a TTP in a TTP sequence constituting the selected seed campaign data, operation S630 of replacing a TTP at a selected mutation position with another TTP, and operation S640 of reflecting a TTP sequence including the replaced TTP in group attribute information of the target group.

According to an embodiment, the mutation position of the TTP may be randomly selected.

According to an embodiment, the mutation position of the TTP may be selected based on the condition setting information 440. The condition setting information 440 may include replacement exclusion information, replacement probability information, and/or dependency information.

According to an embodiment, the TTP at the selected mutation position may be replaced with another TTP included in a synonym range, and the synonym range may correspond to techniques included in the same tactic.

According to an embodiment, when replacing the TTP, at least one other TTP determined to have a dependency relationship according to the dependency information may also be replaced together.

The TTP sequence including the replaced TTP may be applied as campaign data of the target group by being reflected in the group attribute information of the target group.

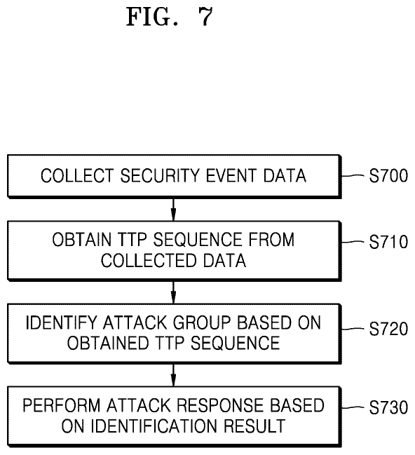

FIG. 7 is a flowchart for explaining a method of operating a security system according to an embodiment.

Referring to FIG. 7, the method of operating the security system 10 may include operation S700 of collecting data (security event data) about the target system 20.

For example, the security system 10 may collect data (network packets, etc.) transmitted and received by the target system 20 through a network and/or log data of the target system 20.

The security system 10 may detect a security event (security abnormality sign, etc.) for the target system 20 from the collected data.

The method of operating may include operation S710 of obtaining a TTP sequence from the collected data.

In more detail, the security system 10 may obtain a TTP sequence by determining a TTP corresponding to each data corresponding to a security event from among the collected data and arranging determined TTPs according to a cyber kill chain process, etc.

The method of operating may include operation S720 of identifying an attack group based on the obtained TTP sequence, and operation S730 of performing an attack response based on an identification result.

For example, the security system 10 may convert the obtained TTP sequence into a campaign vector, and identify an attack group based on similarities between the converted campaign vector and a plurality of campaign vectors for each of a plurality of attack groups.

The security system 10 may protect the target system 20 from a cyber-attack campaign by setting and executing security response measures for the target system 20 or inducing an administrator, etc. to execute security response measures based on the identified attack group and the TTP sequence.

According to the present embodiment, because a large number of campaign data may be secured through data augmentation based on campaign data of an attack group, attack group identification accuracy of the security system 10 may be improved. In particular, in cases where it is difficult to secure sufficient real data, such as in a large-scale cyber-attack campaign, the attack group identification accuracy of the security system 10 is greatly reduced, but according to an embodiment, the problem of reduced attack group identification accuracy may be effectively resolved.

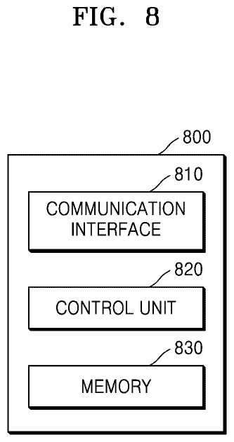

FIG. 8 is a schematic hardware configuration block diagram of a computing device configuring a security system according to an embodiment.

A hardware configuration of the computing device 800 illustrated in FIG. 8 may correspond to a hardware configuration of each of at least one computing device constituting the security system 10 described above.

Referring to FIG. 8, the computing device 800 may include a communication interface 810, a control unit 820, and a memory 830. The control configuration illustrated in FIG. 8 is an example for convenience of explanation, and the computing device 800 may include more components than components illustrated in FIG. 8.

The communication interface 810 may include one or more communication modules that enable communication with other terminals, computing devices, servers, etc. by connecting the computing device 800 to a network. For example, the communication module may include a mobile communication module such as LTE, 5G, etc., a wireless communication module such as Wi-Fi, and/or various other wired or wireless communication modules.

The control unit 820 may control all operations of the computing device 800. The control unit 820 may process signals, data, and information input or output through the components described above, or may provide certain information or functions according to various applications or algorithms stored in the memory 830. For example, the control unit 820 may generally control augmentation of cyber-attack campaign data disclosed in this specification, and an identification operation of an attack group.

The control unit 820 may include at least one processor, and/or at least one programmable circuit. For example, the control unit 820 may be implemented as hardware such as CPU, AP, a micro controller unit (MCU), GPU, NPU, an integrated circuit, ASIC, FPGA, etc.

The memory 830 may store instructions, programs, and data necessary for the operation of the computing device 800. In addition, the memory 830 may store data generated or obtained through the control unit 820. The memory 830 may be composed of a storage medium such as read-only memory (ROM), random-access memory (RAM), flash memory, solid state disk (SSD), or hard disk drive (HDD), or a combination of storage media.

The embodiments described above may be implemented as computer-readable code on a program-recorded medium. The non-transitory computer-readable medium includes all types of recording devices that store data that can be read by a computer system. Examples of the non-transitory computer-readable medium include HDD, SSD, silicon disk drive (SDD), ROM, RAM, compact disc-read only memory (CD-ROM), magnetic tape, floppy disk, optical data storage device, etc.

According to the inventive concept, because a large number of campaign data may be secured through data augmentation based on campaign data of an attack group, the accuracy of identifying an attack group of a security system may be improved.

In particular, in cases where it is difficult to secure sufficient real data, such as in a large-scale cyber-attack campaign, bias may occur when identifying an attack group of a security system, which may significantly reduce the accuracy. However, according to an embodiment, the accuracy of identifying an attack group may be significantly improved even for a large-scale cyber-attack campaign.

Effects obtainable by the inventive concept are not limited to the effects described above, and other effects not described herein may be clearly understood by one of ordinary skill in the art to which the disclosure belongs from the above description.

While the disclosure has been particularly shown and described with reference to embodiments thereof, it will be understood that various changes in form and details may be made therein without departing from the spirit and scope of the following claims.

In addition, it will be apparent to one of ordinary skill in the art that various changes and modifications are possible within a range that does not deviate from the basic principles of the present disclosure.

What is claimed is:

1. A method of augmenting cyber-attack campaign data for identifying an attack group, performed by at least one computing device, the method comprising:
selecting one of a plurality of cyber-attack campaign data for a selected target group from among a plurality of attack groups as seed campaign data;
replacing a first TTP included in a TTP (Tactics, Techniques, Procedures) sequence of the selected seed campaign data with a second TTP included in a synonym range; and
applying a TTP sequence including the replaced second TTP as cyber-attack campaign data for the target group,
wherein the replacing the first TTP with the second TTP comprises:
replacing the first TTP with the second TTP that satisfies predefined condition setting information from among a plurality of TTPs included in a synonym range of the first TTP.

2. The method of claim 1, wherein the selecting one of a plurality of cyber-attack campaign data as seed campaign data comprises:
selecting one of a plurality of cyber-attack campaign data as seed campaign data based on whether a target tactic is included,
wherein the target tactic comprises at least one of Collection, Exfiltration, and Impact.

3. The method of claim 1, wherein the selecting one of a plurality of cyber-attack campaign data as seed campaign data comprises:
selecting one of a certain number of cyber-attack campaign data having a longest TTP sequence length from among the plurality of cyber-attack campaign data for the target group as the seed campaign data.

4. The method of claim 1, wherein the second TTP included in the synonym range is a TTP corresponding to one of techniques included in a same tactic as the first TTP.

5. The method of claim 1, wherein the replacing the first TTP with the second TTP comprises:
randomly selecting a position of a TTP to be replaced from among a plurality of TTPs included in the TTP sequence of the selected seed campaign data; and
replacing the first TTP corresponding to the selected position with the second TTP included in the synonym range.

6. The method of claim 5, wherein the condition setting information comprises at least one of replacement exclusion information, replacement probability information, and dependency information,
wherein the replacement exclusion information comprises information indicating a condition for a tactic to be excluded when selecting a position of a TTP to be replaced,
the replace probability information comprises information about a replacement probability for each tactic, and
the dependency information comprises information about a dependency relationship between tactics and techniques.

7. The method of claim 6, wherein the randomly selecting a position of a TTP to be replaced from among a plurality of TTPs comprises:
among the plurality of TTPs, randomly selecting the position of the TTP to be replaced from at least one TTP from among remaining TTPs excluding at least one TTP corresponding to the replacement exclusion information.

8. The method of claim 6, wherein the randomly selecting a position of a TTP to be replaced from among a plurality of TTPs comprises:
randomly selecting a position of a TTP to be replaced from among a plurality of TTPs by reflecting the replacement probability information.

9. The method of claim 6, wherein the replacing the first TTP corresponding to the selected position with the second TTP included in the synonym range comprises:
when the second TTP has a dependency relationship according to the dependency information, respectively replacing at least one TTP included in the TTP sequence with TTPs corresponding to the dependency relationship.

10. A security system comprising at least one computing device, the security system comprising:
a memory storing at least one instruction; and
at least one processor,
wherein the at least one processor, by processing the at least one instruction, is configured to:
select one of a plurality of cyber-attack campaign data for a selected target group from among a plurality of attack groups as seed campaign data;
replace a first TTP included in a TTP (Tactics, Techniques, Procedures) sequence of the selected seed campaign data with a second TTP included in a synonym range and satisfying predefined condition setting information; and
reflect a TTP sequence including the replaced second TTP as cyber-attack campaign data for the target group in group attribute information.

11. The security system of claim 10, wherein the at least one processor is configured to:
select one of the plurality of cyber-attack campaign data as seed campaign data based on whether a target tactic is included; or
select one of a certain number of cyber-attack campaign data having a longest TTP sequence length from among the plurality of cyber-attack campaign data for the target group as the seed campaign data,
wherein the target tactic comprises at least one of Collection, Exfiltration, and Impact.

12. The security system of claim 10, wherein the second TTP included in the synonym range is a TTP corresponding to one of techniques included in a same tactic as the first TTP.

13. The security system of claim 10, wherein the at least one processor is configured to:
randomly select a position of a TTP to be replaced from among a plurality of TTPs included in the TTP sequence of the selected seed campaign data; and
replace the first TTP corresponding to the selected position with the second TTP included in the synonym range and satisfying the condition setting information.

14. The security system of claim 13, wherein the condition setting information comprises at least one of replacement exclusion information, replacement probability information, and dependency information,
wherein the replacement exclusion information comprises information indicating a condition for a tactic to be excluded when selecting a position of a TTP to be replaced,
the replace probability information comprises information about a replacement probability for each tactic, and
the dependency information comprises information about a dependency relationship between tactics and techniques.

15. The security system of claim 14, wherein the at least one processor is configured to:
among the plurality of TTPs, randomly select the position of the TTP to be replaced from at least one TTP from among remaining TTPs excluding at least one TTP corresponding to the replacement exclusion information.

16. The security system of claim 14, wherein the at least one processor is configured to:
randomly select the position of the TTP to be replaced from among the plurality of TTPs by reflecting the replacement probability information.

17. The security system of claim 14, wherein the at least one processor is configured to:
when the second TTP has a dependency relationship according to the dependency information, respectively replace at least one TTP included in the TTP sequence with TTPs corresponding to the dependency relationship.

18. The security system of claim 10, further comprising:
a communication interface connected to a target system and receiving data generated in relation to the target system,
wherein the at least one processor is configured to:
collect security event data from the received data;
obtain a TTP sequence corresponding to a cyber-attack campaign from the collected security event data;
identify an attack group of the cyber-attack campaign based on the obtained TTP sequence and the group attribute information; and
execute security response measures for the cyber-attack campaign based on an identification result.

19. The security system of claim 18, wherein the at least one processor is configured to:
convert the TTP sequence corresponding to the cyber-attack campaign into sequence data in the form of text;
convert the converted sequence data into a campaign vector; and
identify the attack group based on similarities between a plurality of campaign vectors for each of a plurality of attack groups included in the group attribute information and the converted campaign vector.
